(19) United States
(12) Patent Application Publication
(10) Pub. No.: US 2020/0229469 A1
(43) Pub. Date: Jul. 23, 2020

(54) METHOD FOR PROVIDING A SOURCE OF CONSUMMABLE AND DIGESTIBLE WATER THAT DOES NOT DRY OUT UNDER HEAT

(71) Applicant: PAS REFORM B.V., Zeddam (NL)

(72) Inventors: Wouter Sebastiaan BRUINS, Leiden (NL); Wil Marijn STUTTERHEIM, Leiden (NL)

(73) Assignee: PAS REFORM B.V., Zeddam (NL)

(21) Appl. No.: 16/311,067

(22) PCT Filed: Jun. 21, 2017
(86) PCT No.: PCT/NL2017/050415

§ 371 Date: Dec. 18, 2018

(30) Foreign Application Priority Data
Jun. 24, 2016 (NL) 2017041
Mar. 22, 2017 (NL) 2018563

(51) Int. Cl. A23K 50/60; A23K 20/163; A23K 20/142; A23K 20/174

(52) U.S. Cl. CPC A23K 50/60; A23K 20/163; A23K 50/75; A23K 20/174; A23K 20/142

(57) ABSTRACT

Method for providing a bird, reptile or mammal, for its consumption, with a source of water that does not dry out under prolonged heating conditions by providing an exogenous deep eutectic solvent of water and two or more primary metabolites. In particular, a method for strengthening newly hatched birds during their incubation by providing the birds, for their consumption during their incubation, with the exogenous deep eutectic solvent.

### FIELD OF THE INVENTION

The present invention relates to a method for providing an animal, such as a bird, reptile or mammal for husbandry purposes, for its consumption and digestion, with a source of water that does not dry out under prolonged heating conditions, such as during incubation of its egg, or transport and generally animal feeding and raising conditions under prolonged hot conditions. The invention also relates to the source of water itself. The invention further relates to a method for incubating newly hatched birds or reptiles, particularly birds, with the source of water. The invention still further relates to a method for strengthening newly hatched birds or reptiles, particularly, birds during their incubation with the source of water.

### BACKGROUND OF THE INVENTION

In raising poultry, newly laid eggs are typically incubated under hot (about 37° C.) and dry conditions for up to 21 days until all the fertilized eggs have hatched. The newly hatched birds are then fed with a starter or pre-starter source of food for the birds.

Normally, most chicken eggs hatch in the period between 18 and 21 days after incubation has begun, depending on the kind of incubation technology used. Due to the natural spread of hatch of the chicks over time, some chicks might hatch earlier than others. Research has shown that these chicks, for their further development and resistance to diseases, could benefit from availability of water and food immediately after hatching. See: “Spread of hatch and delayed feed access affect post hatch performance of female broiler chicks up to day 5” Animal (2014), 8:4, pp 610-617; and “The Effects of the Spread of Hatch and Interaction with Delayed Feed Access After Hatch on Broiler Performance Until Seven Days of Age” 2005 Poultry Science (2005) 84:1314-1320

### SUMMARY OF THE INVENTION

It is therefore an object of the present invention to provide a method for providing a source of water that does not dry out under prolonged heating conditions, such as during incubation. It is a further object to provide such a source of water. It is yet a further object to provide a method for incubating newly hatched birds or reptiles with a source of water to strengthen newly hatched birds or reptiles during the time they are residing under incubation conditions.

Accordingly, one aspect of the present invention relates to a method for providing a bird, reptile or mammal, for its consumption and digestion, with a source of water that does not dry out under prolonged heating conditions comprising the step of providing, to the bird, reptile or mammal, an exogenous deep eutectic solvent that comprises water and two or more primary metabolites. Advantageously, the metabolites are plant or animal metabolites which can be safely consumed by the bird, reptile or mammal, such as metabolites found naturally in the bird, reptile or mammal. More advantageously, the metabolites are selected from sugars, sugar alcohols, amino acids, organic acids and choline derivatives. Also advantageously, the deep eutectic solvent is provided to a newly hatched bird or reptile, especially a newly hatched bird, particularly a newly hatched chick, duckling, baby goose or baby turkey, particularly a chick, during its incubation. More advantageously, the deep eutectic solvent is provided, still more advantageously mixed, with a source of food for the bird, reptile or mammal. Still more advantageously, the deep eutectic solvent is provided, still more advantageously mixed, with a starter or pre-starter source of food for a newly hatched bird.

In a further aspect, the invention relates to a source of water for consumption and digestion by a bird, reptile or mammal, undergoing prolonged heating conditions, the source comprising the foregoing exogenous deep eutectic solvent. Advantageously, the deep eutectic solvent is provided to a newly hatched bird or reptile, especially a newly hatched chick, duckling, baby goose or baby turkey, particularly a chick, during its incubation. More advantageously, the deep eutectic solvent is provided, advantageously mixed, with a source of food for the bird, reptile or mammal. Still more advantageously, the deep eutectic solvent is provided, advantageously mixed, with a starter or pre-starter source of food for a newly hatched bird.

In a further aspect, the invention relates to a method for incubating newly hatched birds or reptiles, especially newly hatched chicks, ducklings, baby geese or baby turkeys, particularly chicks, comprising the step of providing the birds or reptiles, for their consumption and digestion during their incubation, with the foregoing exogenous deep eutectic solvent. Advantageously, the deep eutectic solvent is provided, more advantageously mixed, with a source of food for the bird, reptile or mammal, particularly with a starter or pre-starter source of food for a newly hatched bird.

In yet a further aspect, the invention relates to a method for strengthening newly hatched birds or reptiles, especially newly hatched chicks, ducklings, baby geese or baby turkeys, particularly chicks, during their incubation, comprising the step of providing the birds or reptiles, for their consumption during their incubation, with the foregoing exogenous deep eutectic solvent. Advantageously, the deep eutectic solvent is provided, more advantageously mixed, with the deep eutectic solvent is mixed with a source of food for the bird, reptile or mammal for husbandry purposes, particularly with a starter or pre-starter source of food for the newly hatched birds or reptiles.

### DETAILED DESCRIPTION OF THE INVENTION

Unless otherwise stated, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

The term “deep eutectic solvent” or “DES” as used herein preferably means a mixture of water and two or more metabolites which DES can be safely consumed by a bird, reptile or mammal, undergoing prolonged heating conditions and which has a much lower vapour pressure than water and a much lower melting point than any of its components. The metabolites of a DES can generally be any plant or animal (e.g., mammal, fish, reptile, bird or insect) metabolites, i.e., compounds naturally occurring in a plant or animal cell, but can also be synthetic metabolites, provided they can be safely consumed. For certain applications, preferred metabolites of a DES will be those found naturally in a bird, reptile or mammal that is to consume the DES. Generally preferred metabolites include sugars (particularly sucrose, D-glucose, D-galactose, D-mannose, D-fructose, D-xylose, D-trehalose, raffinose and maltose), sugar alcohols (particularly glycerol, adonitol, xylitol, ribitol, 1,2-propanediol, inosiltol, meso-erythritol and D-sorbitol), amino acids (particularly betaine, betanine, proline, arginine, asparagine, betalaine, lysine, threonine, putrescine, cadaverine, glucosamine, glutamine, and alanine), organic acids (particularly lactic acid, malic acid, citric acid, malonic acid, maleic acid, aconitic acid, L-tartaric acid, succinic acid, neuraminic acid, sialic acid, fumaric acid, aspartic acid, glutamic acid [preferably in salt form] and phytic acid [preferably in salt form]) and choline derivatives (particularly choline chloride, acetylcholine, choline citrate and choline bitartrate). Uses of deep eutectic solvents are known, e.g., from WO2015044139 for making flavouring compositions by heating the DES with flavour precursors and from WO2016162703 for extracting natural biological compounds from plant, animal or prokaryotic biological materials.

The term “bird” as used herein preferably includes males or females of any avian species but is primarily intended to encompass poultry which are commercially raised for eggs or meat. Accordingly, the term “bird” is particularly intended to encompass chickens, turkeys, ducks, geese, quails, doves, ostriches, emus, guinea fowl and pheasants.

The term “reptile” as used herein relates to any reptile that is suitably raised from an egg, for husbandry or other purposes, such as species preservation, and preferably includes crocodiles and alligators, tortoise, and any other sort of reptile that could benefit from the feed.

The term “mammal” as used herein relates to animals that are fed at least in part solid food, and may be subjected to similar conditions of high temperatures, such as those occurring during the transport of newly hatched chicks, e.g. during transports of e.g. piglets, calves, or other generally ruminants and monogastrics reared for husbandry. Livestock producers are also greatly interested in techniques for economically achieving enhanced rates of animal weight gain, since such techniques eventually will have the effect, upon maturation of the young mammals, of beneficially reducing milk and meat, e.g. beef, pork, and lamb production costs. Also, livestock producers recognize that the care and feeding of livestock prior to weaning play an important role in determining the amount and quality of products produced by the mammals, upon maturation. The term “mammal” herein preferably means a non-human mammal, more preferably a cow, pig or lamb.

The term “incubation” herein preferably means the process by which oviparian animals, such as birds hatch their eggs, and to the development of the embryo within the egg after leaving the adults' tract. The term “incubation period” herein preferably means the uninterrupted time during which a particular egg is subjected to conditions emulating the brooding until the hatching, i.e. emergence of the hatchlings, including any handling or transfers from e.g. an incubator to a hatchery unit.

The term “exogenous” herein preferably means introduced from or produced outside the organism or system; specifically not synthesized within the organism or system, but prepared from the components.

The term “sugars, sugar alcohols, amino acids, organic acids and choline derivatives” herein preferably means the compounds mentioned in the following Table 1 which can be consumed and digested by a bird, reptile or mammal and can be combined with water to form a deep eutectic solvent of this invention. This term also includes the particularly preferred combinations of compounds mentioned in Table 1 (as described in “Natural deep eutectic solvents as new potential media for green technology” Analytica Chimica Acta 766 (2013) 61-68):

TABLE 1

| Compounds | | | |
|---|---|---|---|
| Compound 1 | Compound 2 | Compound 3 | Mole ratio |
| Choline chloride | Lactic acid | | 1:1 |
| Choline chloride | Malonic acid | | 1:1 |
| Choline chloride | Maleic acid | | 1:1, 2:1, |
| Choline chloride | dl-Malic acid | | 1:1, 1.5:1, |
| Choline chloride | Citric acid | | 1:1, 2:1, |
| Choline chloride | Aconitic acid | | 1:1 |
| Choline chloride | l-(+)-Tartaric acid | | 2:1 |
| Choline chloride | Glycol | | 1:1, 1:2 |
| Choline chloride | 1,2-Propanediol | | 1:1, 1:1.5, 1:2, 1:3 |
| Choline chloride | 1,2-Propanediol | | 2:1 |
| Choline chloride | Glycerol | | 1:1, 3:2 |
| Choline chloride | meso-Erythritol | | 2:1 |
| Choline chloride | Xylitol | | 5:2 |
| Choline chloride | Adonitol | | 5:2 |
| Choline chloride | Ribitol | | 5:2 |
| Choline chloride | d-Sorbitol | | 3:1, 5:2 |
| Choline chloride | d-Xylose | | 2:1, 3:1 |
| Choline chloride | A-L-Rhamnose | | 2:1 |
| Choline chloride | d-(+)-Glucose | | 1:1, 2:1 |
| Choline chloride | d-(+)-Glucose | | 5:2 |
| Choline chloride | d-(−)-Fructose | | 1:1, 1:1.5, 1:2 |
| Choline chloride | d-(−)-Fructose | | 5:2 |
| Choline chloride | Sorbose | | 5:2, 1:1 |
| Choline chloride | d-Mannose | | 5:2 |
| Choline chloride | d-(+)-Galactose | | 5:2 |
| Choline chloride | Sucrose | | 4:1, 1:1 |
| Choline chloride | d-(+)-Trehalose | | 4:1 |

| Compound 1 | Compound 2 | Compound 3 | Molee Ratio |
|---|---|---|---|
| Choline chloride | Maltose | | 4:1 |
| Choline chloride | Raffinose | | 11:2 |
| Choline chloride | Proline | dl-Malic acid | 1:1:1 |
| Choline chloride | Xylitol | dl-Malic acid | 1:1:1 |
| Choline bitartrate | d-(+)-Glucose | | 1:1 |
| Betaine | d-(+)-Glucose | | 5:2 |
| Betaine | Sucrose | | 4:1, 1:1 |
| Betaine | Sucrose | | 2:1 |
| Betaine | d-(+)-Trehalose | | 4:1 |
| Betaine | d-Sorbitol | | 3:1 |
| Betaine | dl-Malic acid | | 1:1 |
| Betaine | l-(+)-Tartaric acid | | 2:1 |
| Betaine | d-Mannose | | 5:2 |
| Betaine | Inositol | Raffinose | 9:1:1 |
| Betaine | Sucrose | Proline | 1:1:1 |
| Betaine | Sucrose | Proline | 5:2:2 |
| Betaine | d-(+)-Glucose | Proline | 1:1:1 |
| Betaine | dl-Malic acid | d-(+)-Glucose | 1:1:1 |
| Betaine | dl-Malic acid | Proline | 1:1:1 |
| Betaine | dl-Malic acid | Inositol | 1:1:1 |
| Betaine | Oxalic acid | d-(+)-Glucose | 1:1:1 |
| Betaine | Citric acid | | 1:1 |
| Lactic acid | d-(+)-Glucose | | 5:1 |
| Lactic acid | beta-Alanine | | 1:1 |
| dl-Malic acid | d-Xylose | | 1:1 |
| dl-Malic acid | d-(+)-Glucose | | 1:1, 1:2 |
| dl-Malic acid | Sucrose | | 1:1 |
| dl-Malic acid | d-(−)-Fructose | | 1:1 |
| dl-Malic acid | d-Mannose | | 1:1 |
| dl-Malic acid | Sucrose | | 1:1, 2:1 |
| dl-Malic acid | Maltose | | 2:1 |
| dl-Malic acid | d-(+)-Trehalose | | 2:1 |

| Compound 1 | Compound 2 | Compound 3 | Mole Ratio |
|---|---|---|---|
| dl-Malic acid | Lactose | | 2:1, 1:1 |
| dl-Malic acid | Raffinose | | 3:1 |
| dl-Malic acid | Xylitol | | 1:1 |
| dl-Malic acid | Adonitol | | 1:1 |
| dl-Malic acid | d-Sorbitol | | 1:1 |
| dl-Malic acid | d-(+)-Glucose | d-(−)-Fructose | 1:1:1 |
| dl-Malic acid | d-(+)-glucose | Glycerol | 1:1:1 |
| dl-Malic acid | Sucrose | Glycerol | 1:1:2 |
| dl-Malic acid | l-Proline | Choline chloride | 1:1:1 |
| Citric acid | d-Xylose | | 1:1 |
| Citric acid | d-(+)-Glucose | | 2:1 |
| Citric acid | d-(−)-Fructose | | 1:1 |
| Citric acid | Sorbose | | 1:1 |
| Citric acid | d-Mannose | | 1:1 |
| Citric acid | d-(+)-Galactose | | 1:1 |
| Citric acid | Sucrose | | 1:1 |
| Citric acid | Maltose | | 2:1 |
| Citric acid | d-(+)-Trehalose | | 2:1 |
| Citric acid | Raffinose | | 3:1 |
| Citric acid | d-Sorbitol | | 1:1 |
| Citric acid | Ribitol | | 1:1 |
| Citric acid | Xylitol | | 1:1 |
| Citric acid | Adonitol | | 1:1 |
| Citric acid | l-Proline | | 1:1, 1:2, 1:3 |
| Citric acid | dl-Malic acid | | 1:1 |
| Phytic acid sodium | Betaine | | 1:6 |
| Phytic acid sodium | dl-Malic acid | | 1:6 |
| Phytic acid sodium | Glycerol | | 1:6 |
| Phytic acid sodium | l-Proline | | 1:6 |
| Phytic acid sodium | d-(+)-Glucose | | 1:6 |
| Phytic acid sodium | Choline chloride | | 1:3 |
| d/l-Proline | Sucrose | | 2:1, 3:1 |
| d/l-Proline | Sucrose | | 4:1, 1:1a |
| d/l-Proline | d-Sorbitol | | 1:1 |
| d/l-Proline | d-(+)-Glucose | | 1:1, 5:3 |
| d/l-Proline | Lactic acid | | 1:1 |
| d/l-Proline | dl-Malic acid | | 1:1 |
| d/l-Proline | Citric acid | | 1:1, 2:1 |
| d/l-Proline | Malonic acid | | 1:1a |
| d-Proline | d-(+)-Glucose | | 5:3 |
| l-Proline | d-(+)-Glucose | | 5:3 |
| l-Serine | dl-Malic acid | | 3:2, 1:1 |
| l-Serine | d-(+)-Glucose | | 5:4 |
| l-Glutamic salt | Sucrose | | 2:1 |
| l-Glutamic salt | d-(+)-Glucose | | 1:1 |
| d-(+)-Glucose | dl-Malic acid | | 1:1 |
| d-(+)-Glucose | Citric acid | | 1:1 |
| d-(+)-Glucose | l-(+)-Tartaric acid | | 1:1 |
| d-(+)-Glucose | d-(−)-Fructose Sucrose | | 1:1:1 |
| d-(−)-Fructose | Sucrose | | 1:1 |
| beta-Alanine | dl-Malic acid | | 3:2, 1:1 |
| beta-Alanine | Citric acid | | 1:1 |

Of course, equivalents of these compounds as well as many others compounds could be formulated with water in a conventional manner into a deep eutectic solvent of this invention.

In accordance with this invention, a bird, reptile or mammal can be provided with a source of water that does not dry out under prolonged heating conditions. This is done by providing the bird, reptile or mammal, for its consumption and digestion, with an exogenous deep eutectic solvent or DES that comprises water and two or more primary metabolites. Preferably, the primary metabolites are selected from sugars, sugar alcohols, amino acids, organic acids and choline derivatives. More preferably, the deep eutectic solvent is provided, even more preferably mixed, with a source of food for the bird, reptile or mammal. In this regard, the DES and food for a bird, retile or mammal can be separate in different containers or separate in one container or combined as a mixture in one container. Even more preferably, the deep eutectic solvent is fed to a newly hatched bird or reptile, particularly a newly hatched chick, duckling, baby goose or baby turkey, during its incubation. In this regard, the deep eutectic solvent is preferably provided, more preferably mixed, with a starter or pre-starter source of food for a newly hatched bird. In this regard, any conventional chick starter or pre-starter feed can be used.

Also in accordance with this invention, a source of water can be provided for consumption and digestion by a bird, reptile or mammal, undergoing prolonged heating conditions. This is done by providing the exogenous deep eutectic solvent that comprises water and two or more primary metabolites, preferably selected from plant and animal, sugars, sugar alcohols, amino acids, organic acids and choline derivatives. Preferably, the DES is mixed with a source of food for the bird, reptile or mammal. Even more preferably, the DES is provided to a newly hatched bird or reptile, particularly a newly hatched chick, duckling, baby goose or baby turkey, during its incubation. In this regard, the DES is preferably provided, more preferably mixed, with a starter or pre-starter source of food for a newly hatched bird, particularly a chick.

Also in accordance with this invention, newly hatched birds or reptiles, particularly birds, more particularly chicks, are incubated while being provided with the foregoing exogenous deep eutectic solvent for their consumption and digestion. Preferably, the deep eutectic solvent is provided, more preferably mixed, with a starter or pre-starter source of food for the newly hatched birds or reptiles.

Also in accordance with this invention, newly hatched birds or reptiles, particularly birds, more particularly chicks, are strengthened during and after their incubation by providing the birds or reptile, for their consumption, with the foregoing exogenous deep eutectic solvent. Preferably, the DES is mixed with a starter or pre-starter source of food for the newly hatched birds or reptiles.

The exogenous deep eutectic solvent can be provided to a bird, reptile or mammal in any conventional manner used to feed the bird, reptile or mammal. In this regard, the DES can be provided in liquid form or gel form (e.g., mixed with gelatine, agar or pectin). The deep eutectic solvent can also be mixed with a source of food for the bird, reptile or mammal to form a slurry or paste. Preferably, newly hatched birds, particularly chicks, are incubated while being provided in their incubation tray in a hatchery with the DES, preferably mixed with a starter or pre-starter source of food, for their consumption and digestion. Thereby, the birds will have water and preferably food available to them as soon as they hatch.

The ratio of the metabolites to each other in each deep eutectic solvent used in the different aspects of this invention is not critical and will depend on the physical and chemical characteristics of the metabolites used in the DES and the intended uses of the DES. Likewise, the ratio of the water to the metabolites in the deep eutectic solvent is not critical and will depend on the physical and chemical characteristics of the metabolites used in the DES and the intended uses of the DES.

Likewise, the ratio of the DES to a food for a bird, reptile or mammal, with which the DES is mixed, is not critical and will depend on the physical and chemical characteristics of the DES and food and the intended uses of the mixture.

In this regard, a mixture of a DES with food for a newly hatched bird, particularly a chick, preferably has a water content of at least 10%, preferably at least 20%, more preferably at least 25%, up to about 60%. To maximize the water content, the DES is preferably in the form of a gel and/or the food is in the form of pellets that do not readily dissolve in water.

A preferred DES composition comprises a DES comprising 60% water. The composition may advantageously comprise of from 35 to 45% of a fructose syrup, which may comprise in itself of from 18 to 22%, preferably 20% water; dissolved choline-chloride comprising 25% water, and pectin in a range of from 1 to 3%, preferably of from 1.5 to 2.5%, such as 2.0% of pectin, and of from 0.5 to 1.5%, such as preferably 0.75% of calcium lactate, and of from 45 to 55% of water.

The DES composition may then be blended with a grain based pre-starter feed, for instance in a ratio of feed to DES ranging from a ratio of from 25 to 75%, to a ratio of 85:15, preferably of from 20:80 to 80:20, more preferably of from 40:60 to 60:40, and yet more preferably 50:50.

The present invention also preferably relates to a storage stable food composition comprising a source of water that does not dry out under prolonged heating conditions, comprising an exogenous deep eutectic solvent that comprises water and two or more primary components that can metabolized by a bird, reptile or mammal, and further comprising nutrients for the bird, reptile or mammal. The invention also preferably relates to the preparation of a source of water, or a food composition, comprising the steps of: (a) providing the components of a deep eutectic solvent, and (b) preparing an exogenous deep eutectic solvent, and (c) mixing or blending the deep eutectic solvent with nutrients, preferably a starter or pre-starter source of food, to obtain a stable composition suitable for consumption. The mixing or blending step is advantageously executed in a manner that will not affect the stability of the deep eutectic solvent mixture by removing components therefrom, and can include stabilization by gelation or encapsulation of the exogenous deep eutectic solvent. This preferably allows the physical blending of the deep eutectic solvent with solid food components or nutrients as solid or gel particles.

The following examples serve to illustrate the invention further.

### Example 1

a complementary feed for poultry directly after hatching was prepared, by adding a deep eutectic material to a premix of grains and other components, at 1.5% addition.

Table 2 shows the composition as measured/calculated. Hatchlings were offered the feed, which was well taken up.

TABLE 2
Complementary feed for poultry after hatching

| | | |
|---|---|---|
| Calculated Analysis: | pre-Mix | End Products |

Analytical content

| | | | | | |
|---|---|---|---|---|---|
| 001 | Moisture | 420.25 | g/kg | 6.30 | g/kg |
| 002 | Dry mater | 579.75 | g/kg | 8.70 | g/kg |
| 003 | Crude ash* | 39.14 | g/kg | 0.59 | g/kg |
| 004 | Crude Protein* | 94.76 | g/kg | 1.42 | g/kg |
| 005 | Crude Fat* | 32.52 | g/kg | 0.49 | g/kg |
| 006 | Crude Fibre* | 12.93 | g/kg | 0.19 | g/kg |

Minerals

| | | | | | |
|---|---|---|---|---|---|
| 031 | Calcium* | 3.86 | g/kg | 0.06 | g/kg |
| 032 | Phosphorus* | 2.41 | g/kg | 0.04 | g/kg |
| 033 | Magnesium* | 0.69 | g/kg | 0.01 | g/kg |
| 035 | Sodium* | 0.95 | g/kg | 0.01 | g/kg |
| 036 | Chloride | 6.62 | g/kg | 0.10 | g/kg |
| 038 | Sulpher | 1.19 | g/kg | 0.02 | g/kg |

Amino Acids

| | | | | | |
|---|---|---|---|---|---|
| 070 | Lysine (3.2.3) | 6.28 | g/kg | 0.09 | g/kg |
| 071 | Methionine (3c301) | 2.94 | g/kg | 0.04 | g/kg |
| 073 | Meth. + Cyst. | 4.48 | g/kg | 0.07 | g/kg |
| 074 | Threonine (3.3.1) | 4.15 | g/kg | 0.06 | g/kg |
| 075 | Tryptophan (3.4.1) | 1.12 | g/kg | 0.02 | g/kg |
| 082 | L-Valine (3c369) | 4.63 | g/kg | 0.07 | g/kg |
| 455 | Glutamate (E620) | 6.42 | g/kg | 0.10 | g/kg |

Nutritional additives

| | | | | | |
|---|---|---|---|---|---|
| 499 | Vit A Retinylacetate (3a672a)* | 6.078.31 | IU/kg | 91.17 | IU/kg |
| 402 | Vitamin D3 (E671)* | 810.44 | IU/kg | 12.16 | IU/kg |
| 494 | Vit. D 25-hydroxycholecalciferol (E3a670a)* | 810.44 | IU/kg | 12.16 | IU/kg |
| 496 | Vitamin E di-a-tocoph.-acet. (3a700) | 40.52 | mg | 0.61 | mg |
| 502 | Vit K3 Menadion | 1.22 | mg | 0.02 | mg |
| 593 | Vit B1 Thiamine | 1.42 | mg | 0.02 | mg |
| 505 | Vit B2 Riboflavine | 3.24 | mg | 0.05 | mg |
| 506 | Vit. PP Niacinamide (3a315) | 30.39 | mg | 0.46 | mg |
| 507 | Pantothenic acid, (Calcium-Dpantothenate) (3a841) | 7.09 | mg | 0.11 | mg |
| 508 | Vitamin B6 Pyridoxine (3a831) | 2.43 | mg | 0.04 | mg |
| 509 | Vit B12 Cyanocobalamine | 16.21 | mcg/kg | 0.24 | mcg/kg |
| 510 | Biotin (3a880) | 202.61 | mcg/kg | 3.04 | mcg/kg |
| 511 | Vit B4 Choline Chloride (3a890) | 32,131.57 | mg | 481.97 | mg |
| 512 | Choline | 27,940.38 | mg | 419.11 | mg |
| 513 | Vit B9 Folic Acid (3a316) | 0.81 | mg | 0.01 | mg |
| 515 | Vit C Sodium L-ascorbaat (stable) | 50.65 | mg | 0.76 | mg |
| 517 | Betaine (3a925) | 40.52 | mg | 0.61 | mg |
| 519 | L-Carnitine (3a910) | 16.21 | mg | 0.24 | mg |

Technological additives

| | | | | | |
|---|---|---|---|---|---|
| 482 | Butylated hydroxytoluene (BHT)* | 1.69 | mg | 0.03 | mg |
| 484 | Propyl gallate (E310)* | 1.69 | mg | 0.03 | mg |

Nutritional additives

| | | | | | |
|---|---|---|---|---|---|
| 542 | Iron(II)sulphate monohydrate E1* | 20.26 | mg | 0.30 | mg |
| 547 | I-Calcium iodate (3b202)* | 1.01 | mg | 0.02 | mg |
| 550 | Copper(II)sulphate-pentahydrate E4* | 6.08 | mg | 0.09 | mg |
| 658 | Manganese(II)oxide E5* | 32.42 | mg | 0.49 | mg |
| 561 | Zinc oxide 3b603* | 20.26 | mg | 0.30 | mg |
| 563 | Zn chelate of glycine, hydrated 3b607* | 12.16 | mg | 0.18 | mg |
| 571 | Sodium selenite E8* | 0.08 | mg | 0.00 | mg |
| 567 | E8 Se-organic CNCM I-3399 n* 3b8.12* | 0.06 | mg | 0.00 | mg |

Zootechnical additives

| | | | | | |
|---|---|---|---|---|---|
| 711 | 6-Phytase EC 3.1.3.26 (4a18)* | 405.22 | FYT/kg | 6.08 | FYT/kg |
| 721 | Endo-1,4-beta-xylanase EC3.2.1.8 (4a7)* | 351.73 | TXT/kg | 5.28 | TXT/kg |
| 722 | Endo-1,4-β-glucanase EC3.2.1.4 (4a7)* | 157.02 | TGU/kg | 2.36 | TGU/kg |

Technological additives

| | | | | | |
|---|---|---|---|---|---|
| 620 | Ca-lactate (E327) | 3.00 | g/kg | 0.05 | g/kg |
| 821 | E330 Citric Acid* | 10.35 | g/kg | 0.16 | g/kg |
| 827 | Calciumpropionate (E282)* | 0.77 | g/kg | 0.01 | g/kg |
| 828 | E202 K-sorbate* | 1.82 | g/kg | 0.03 | g/kg |

Physical properties

| | | | | | |
|---|---|---|---|---|---|
| 600 | Silicim (E551b)* | 7.88 | g/kg | 0.12 | gk/g |
| 601 | E484 Polyethyleenglycol- | 0.60 | mg | 0.01 | mg |
| | glyceryltricinoleaat* | | | | |

### Example 2

A second feed mix was prepared, as shown in Example 1. Table 3 lists the composition of the premix and the final product:

TABLE 3

| | | | | | |
|---|---|---|---|---|---|
| 505 | Vit B2 Riboflavine | 3.24 | mg | 0.05 | mg |
| 506 | Vit. PP Niacinamide (3a315) | 30.39 | mg | 0.46 | mg |
| 507 | Pantothenic acid, (Calcium- | 7.09 | mg | 0.11 | mg |
| | Dpantothenate) (3a841) | | | | |
| 508 | Vitamin B6 Pyridoxine (3a831) | 2.43 | mg | 0.04 | mg |
| 509 | Vit B12 Cyanocobalamine | 16.21 | mcg/kg | 0.24 | mcg/kg |
| 510 | Biotin (3a860) | 202.61 | mcg/kg | 3.04 | mcg/kg |
| 511 | Vit B4 Choline Chloride (3a890) | 32,131.57 | mg | 481.97 | mg |
| 512 | Choline | 27,940.38 | mg | 419.11 | mg |
| 513 | Vit B9 Folic Acid (3a316) | 0.81 | mg | 0.01 | mg |
| 515 | Vit C Sodium L-ascorbaat (stable) | 50.65 | mg | 0.76 | mg |
| 517 | Betaine (3a925) | 40.52 | mg | 0.61 | mg |
| 519 | L-Carnitine (3a910) | 16.21 | mg | 0.24 | mg |

Technological additives

| | | | | | |
|---|---|---|---|---|---|
| 482 | Butylated hydroxytaluene (BHT)* | 1.69 | mg | 0.09 | mg |
| 484 | Propyl gallate (E310)* | 1.69 | mg | 0.03 | mg |

Nutritional additives

| | | | | | |
|---|---|---|---|---|---|
| 542 | Iron(II)sulphate monohydrate E1* | 20.26 | mg | 0.30 | mg |
| 547 | I-Calcium iodate (3b202)* | 1.01 | mg | 0.02 | mg |
| 550 | Copper(II)sulphate-pentahydrate E4* | 6.08 | mg | 0.09 | mg |
| 555 | Manganese(II)oxide E5* | 32.42 | mg | 0.49 | mg |
| 561 | Zinc oxide 3b603* | 20.26 | mg | 0.30 | mg |
| 563 | Zn chelate of glycine, hydrated 3b607* | 12.16 | mg | 0.18 | mg |
| 571 | Sodium selenite E8* | 0.08 | mg | 0.00 | mg |
| 567 | E8 Se-organic CNCM I-3399 n* 3b8.12* | 0.06 | mg | 0.00 | mg |

Zootechnical additives

| | | | | | |
|---|---|---|---|---|---|
| 711 | 6-Phytase EC 3.1.3.26 (4a18)* | 405.22 | FYT/kg | 6.08 | FYT/kg |
| 721 | Endo-1,4-beta-xylanase EC3.2.1.8 (4a7)* | 351.73 | TXT/kg | 5.28 | TXT/kg |
| 722 | Endo-1,4-β-glucanase EC3.2.1.4 (4a7)* | 157.02 | TGU/kg | 2.36 | TGU/kg |

Technological additives

| | | | | | |
|---|---|---|---|---|---|
| 620 | Ca-lactate (E327) | 3.00 | g/kg | 0.05 | g/kg |
| 621 | E330 Citric Acid* | 10.35 | g/kg | 0.16 | g/kg |
| 627 | Calciumpropionate (E262)* | 0.77 | g/kg | 0.01 | g/kg |
| 628 | E202 K-sorbate* | 1.82 | g/kg | 0.03 | g/kg |

Physical properties

Analytical content

| | | | | | |
|---|---|---|---|---|---|
| 001 | Moisture | 420.25 | g/kg | 6.30 | g/kg |
| 002 | Dry matter | 579.75 | g/kg | 8.70 | g/kg |
| 003 | Crude ash* | 39.14 | g/kg | 0.59 | g/kg |
| 004 | Crude Protein* | 94.76 | g/kg | 1.42 | g/kg |
| 005 | Crude Fat* | 32.52 | g/kg | 0.49 | g/kg |
| 006 | Crude Fibre* | 12.93 | g/kg | 0.19 | g/kg |

Minerals

| | | | | | |
|---|---|---|---|---|---|
| 031 | Calcium* | 3.86 | g/kg | 0.06 | g/kg |
| 032 | Phosphorus* | 2.41 | g/kg | 0.04 | g/kg |
| 033 | Magnesium* | 0.69 | g/kg | 0.01 | g/kg |
| 035 | Sodium* | 0.95 | g/kg | 0.01 | g/kg |
| 036 | Chloride | 6.62 | g/kg | 0.10 | g/kg |
| 038 | Sulpher | 1.19 | g/kg | 0.02 | g/kg |

Amino Acids

| | | | | | |
|---|---|---|---|---|---|
| 070 | Lysine (3.2.3) | 6.28 | g/kg | 0.09 | g/kg |
| 071 | Methionine (3c301) | 2.94 | g/kg | 0.04 | g/kg |
| 073 | Meth. + Cyst. | 4.48 | g/kg | 0.07 | g/kg |
| 074 | Threonine (3.3.1) | 4.15 | g/kg | 0.06 | g/kg |
| 075 | Tryptophan (3.4.1) | 1.12 | g/kg | 0.02 | g/kg |
| 062 | L-Valine (3c369) | 4.63 | g/kg | 0.07 | g/kg |
| 455 | Glutamate (E620) | 6.42 | g/kg | 0.10 | g/kg |

Nutritional additives

| | | | | | |
|---|---|---|---|---|---|
| 490 | Vit A Retinylacetate (3a672a)* | 6,078.31 | mg | 91.17 | mg |
| 492 | Vitamin D3 (E671)* | 810.44 | mg | 12.16 | mg |
| 494 | Vit. D 25-hydroxycholecalciferol (E3a670a)* | 810.44 | mg | 12.16 | mg |
| 496 | Vitamin E di-sa-tocoph.-acet (3a700) | 40.52 | mg | 0.61 | mg |
| 502 | Vit K3 Menadion | 1.22 | mg | 0.02 | mg |
| 503 | Vit B1 Thiamine | 1.42 | mg | 0.02 | mg |

1. A method for providing a bird, reptile or mammal, for its consumption, with a source of water that does not dry out under prolonged heating conditions comprising the step of providing, to the bird, reptile or mammal, an exogenous deep eutectic solvent that comprises water and two or more primary metabolites.

2. The method of claim 1 wherein the primary metabolites are plant or animal metabolites which can be safely consumed by the bird, reptile or mammal, or are metabolites found naturally in the bird, reptile or mammal.

3. The method of claim 1, wherein the primary metabolites are selected from sugars, sugar alcohols, amino acids, organic acids and choline derivatives.

4. The method of claim 1, wherein the deep eutectic solvent is provided with, or mixed with, a source of food for the bird, reptile or mammal.

5. The method of claim 1, wherein the deep eutectic solvent is provided to a newly hatched bird or reptile.

6. The method of claim 5 wherein the deep eutectic solvent is provided with, or mixed with, a starter or pre-starter source of food for a newly hatched bird or a newly hatched chick.

7. A source of water for consumption by a bird, reptile or mammal, undergoing prolonged heating conditions, the source comprising the exogenous deep eutectic solvent of claim 1.

8. The source of claim 7 wherein the deep eutectic solvent is provided to a newly hatched bird or reptile during its incubation.

9. The source of claim 8 wherein the deep eutectic solvent is provided with, or mixed with, a starter or pre-starter source of food for a newly hatched bird or a newly hatched chick.

10. The source of claim 9, comprising the pre-starter source of food and the deep eutectic solvent in a weight ratio of from 15:85 to 85:15.

11. A method for incubating newly hatched birds or reptiles, comprising the step of providing the birds or reptiles, for their consumption during their incubation, with the exogenous deep eutectic solvent of claim 1.

12. The method of claim 11 wherein the deep eutectic solvent is provided, preferably mixed, with a starter or pre-starter source of food for a newly hatched bird or a newly hatched chick.

13. A method for strengthening newly hatched birds or reptiles during their incubation, comprising the step of providing the birds or reptiles, for their consumption during their incubation, the exogenous deep eutectic solvent of claim 1.

14. The method of claim 13 wherein the deep eutectic solvent is provided with, or mixed with, a starter or pre-starter source of food for a newly hatched bird.

15. The method of claim 5, wherein the newly hatched bird is selected from any of the group of: a newly hatched chick, turkey, duck, goose, quail, dove, ostrich, emu, guinea fowl or pheasant.

16. The method of claim 15, wherein the a newly hatched bird is a chick, duckling, baby goose or baby turkey.

17. The method of claim 8, wherein the newly hatched bird is selected from any of the group of: a newly hatched chick, turkey, duck, goose, quail, dove, ostrich, emu, guinea fowl or pheasant.

18. The method of claim 17, wherein the a newly hatched bird is a chick, duckling, baby goose or baby turkey.

19. The method of claim 14, wherein the a newly hatched bird is a newly hatched chick.
